(19) United States
(12) Patent Application Publication
(10) Pub. No.: US 2003/0048880 A1
(43) Pub. Date: Mar. 13, 2003

(54) Voice identification pre-screening and redirection system

(75) Inventors: Steve Horvath, Ottawa (CA); Tonis Kasvand, Ottawa (CA)

Correspondence Address: James W. McKee, Fay, Sharpe, Fagan, Minnich & McKee, LLP, 7th Floor, 1100 Superior Avenue, Cleveland, OH, 44114-2518, US

(73) Assignee: Mitel Knowledge Corporation

(21) Appl. No.: 10/236,810

(22) Filed: Sep. 6, 2002

(30) Foreign Application Priority Data
Sep. 12, 2001 (GB) 0122079.7

(51) Int. Cl. H04M 1/64

(52) U.S. Cl. 379/88.01; 379/88.22

(57) ABSTRACT

A system is provided that automates the process of pre-screening calls by reliably identifying callers and directing calls according to user preferences related to specific callers. The automated system answers an incoming call, communicates with the caller, identifies the caller through their unique voice pattern, and redirects the call according to associated policies and/or feature specifications set by the receiver.

### FIELD OF INVENTION

This invention relates generally to voice communications systems. More particularly, the invention relates to a method and apparatus for pre-screening and redirecting incoming calls based on features, policy rules, or execution commands associated with a caller's voice print identification.

### BACKGROUND OF THE INVENTION

Caller Line Identification (CLID) is a useful feature by which the identity of a caller may established for the purpose of call screening or call redirection. However, the efficacy of systems that rely on CLID is negated when CLID data is blocked (e.g. by mobile phones, proxy communication points, Caller ID blocking options, etc.). When the CLID data is blocked, the names and phone numbers of calling parties remain anonymous. Another problem with using CLID data arises when several individuals share one phone, in which case caller ID cannot identify who specifically is calling.

Recipients of calls can, of course, screen such calls via secretarial or automated attendant intervention. However, such intervention makes it difficult to allow phone calls from specific individuals and not others since most ‘Caller ID’ data is not passed to the receiver of the call once the call has been answered by the secretary or automated attendant system. The result is that the receiver often does not know who is calling therefor no opportunity is provided to screen or re-direct the call before the receiver answers it.

As a result of the foregoing shortcomings, there is no way to reliably identify a caller for the purpose of automatic screening or redirecting of a call using existing communications systems. As people's schedules become busier and long distance calls become less expensive, the potential for more unwanted phone calls from sales agents or automated calling systems (i.e. “Voice Spam”) is expected to increase It is therefore desirable to provide a system for automatically screening and redirecting calls without relying on unreliable CLID data.

### SUMMARY OF THE INVENTION

According to the present invention, a software application is provided that automates the process of pre-screening calls by reliably identifying callers and directing calls according to user preferences related to specific callers. More particularly, an automated system is provided that answers an incoming call, communicates with the caller, identifies the caller through their unique voice pattern, and redirects the call according to the associated policies and/or feature specifications set by the receiver.

The present invention may be implemented to advantage in both commercial and residential telephony markets for situations where individuals do not have time to answer many calls or receive calls from many different types of callers (customers, vendors, personal friends, etc.). The present invention is particularly useful in enhancing Customer Relationship Management (CRM) systems since a caller can be identified and associated processes can be activated to handle the call upon receipt (e.g. “elite” customers receive immediate attention).

### BRIEF DESCRIPTION OF THE DRAWINGS

A detailed description of the preferred embodiment is set forth herein below, with reference to the following drawings, in which:

FIG. 1 which is a block diagram of a communication system for pre-screening and redirecting incoming calls in accordance with the preferred embodiment of the invention; and

FIG. 2 is a graphical user interface of a menu of caller identifications and associated preferences.

### DETAILED DESCRIPTION OF THE PREFERRED EMBODIMENTS

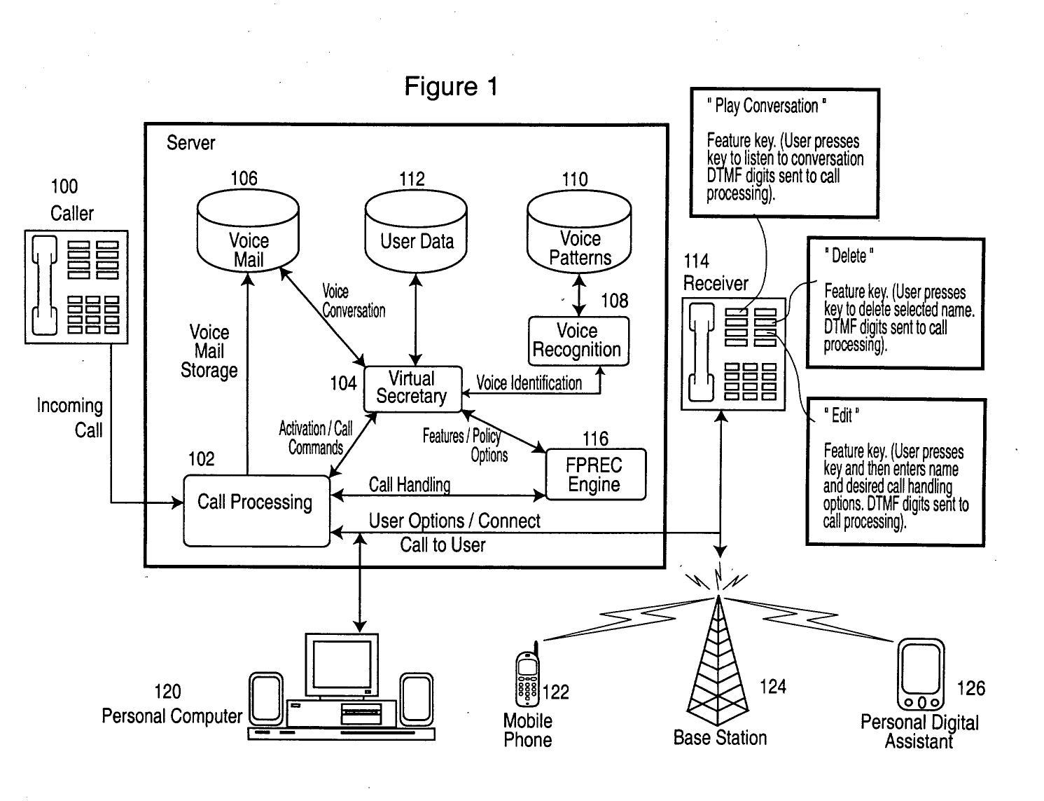

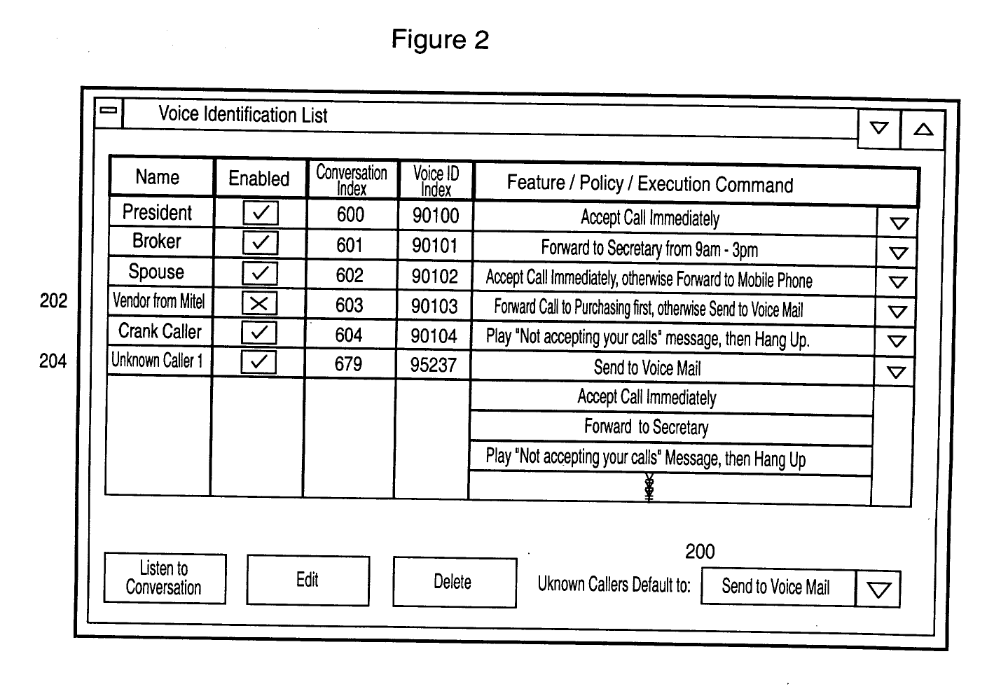

Referring to FIG. 1, a communication system is shown for receiving a telephone call from a caller at a phone 100 which is intended for a particular receiver at a respective phone 114. The phone call is handled by Call Processing (CP) software 102 residing in a PBX server or similar communication handling device. The CP 102 signals a Virtual Secretary (VS) 104 that a call is incoming. The VS 104 tells the CP 102 to answer the call and the VS 104 plays a greeting message which asks the caller questions requiring spoken response from the caller. The responses from the caller are recorded and stored in Voice Mail (VM) 106. As the caller is speaking, the Voice Recognition Software (VRS) 108 (such as Speak@Ease from Mitel Networks) analyzes the caller's voice to determine the caller's Unique Voice IDentification (UV-ID). The caller's UV-ID is then matched with previously stored UV-ID's in a Voice Patterns DataBase (VP-DB) 110 to determine if the caller has been previously identified. If the caller's UV-ID is matched in the VP-DB 110, this match is communicated to the VS 104 which invokes the appropriate profile 202 (FIG. 2) for screening or redirecting the call. If the caller's UV-ID is not identified then the new UV-ID is recorded, a new UV-ID Index (VID) is created and associated with the new UV-ID, and then sent to the VS 104. The VM 106 receives the VID Index and a check is performed against the UV-ID's it has stored in the User database 12. If no UV-ID matches, which means that the caller does not have a profile set up yet in the VS 104 then the call is redirected according to the default settings for unknown callers 200, as discussed in greater detail below.

With reference to FIG. 2, each profile 202 is saved in the user database 112. The profiles each include: a Name for identifying the identity of the caller; an “Enabled” switch which, when checked, causes associated Feature/Policy/Execution Commands (FPREC) to be executed; a Conversation Index which matches the caller's conversation with the VS 104 that is stored in the Voice Mail database 106; and the Voice ID Index (i.e. VID Index).

With respect to the Features, Policy Rules, or Execution Commands (FPREC), “Features” are those implemented by conventional PBX systems for call handling. “Policy Rules” are rules that can be checked against policy guidelines to determine external security protocols, user preferences, etc. “Execution Commands” are any commands that execute or activate any activity or application not covered by Features or Policy Rules. The FPREC engine 116 invokes call handling features via CP 102, such as the features found in the MN3300 switch manufactured by Mitel Networks Corporation (see http://www.mitel.com, and incorporates a policy/feature interaction engine such as LOTOS http://www.site.uottawa.ca/˜luigi/

In the event of an unknown caller, the call is logged and a profile is built (204). The profile includes a default name (Unknown Caller, Unknown Caller 2, Unknown Caller 3, etc. . . . ), the Enabled option is checked, a unique conversation index is generated, a VID Index is generated, and the default FPREC (200) for unknown callers.

The Recipient can use a phone (POTS) 114, mobile phone 122, Personal Digital Assistant (PDA) 126 (or other wireless communication device connected via wireless network 124), or a desktop application 120, etc. to change the name of the callers, to enable the callers, to change the FPREC of callers, or delete callers. Indeed, any device that is capable of modifying the menu items may be used.

By clicking on the ‘Listen to Conversation’ button (FIG. 2) the Recipient can hear the last conversation made by the caller and the VS 104.

If the UV-ID index received from the VR 108 matches a UV-ID index in the profile, the FPREC in that associated profile is activated by informing the FPREC engine 116 of the option chosen (in whatever protocol/execution command/etc. that is necessary) to handle the call. The FPREC engine tells the CP 102 to handle the call accordingly.

The following pseudo-code is exemplary of the preferred embodiment:

Call Handling Behaviour

Caller calls the Receiver

CP picks up call and VS is notified

VS plays greeting, records Callers speech

As Caller speaks, VRS forms UV-ID of caller and attempts to match with Voice Print database

UV-ID Index sent to VS

VS matches against UV-ID Index of Profiles

If no UV-ID matches

A Profile is built and the UV-ID is matched to the new Profile Endif

The VS plays ‘re-direction’ message

The FPREC of the matched Profile is activated to handle the call

The Caller's conversation index is updated and associated with the Caller's speech with the VS

The User database is updated with the changes

The call is handled

Voice Identification List Menu

Listen to Conversation

If user has not highlighted button/clicked/chosen a name

Message appears “please click on a profile”

Else if

Play conversation associated with the profile through the phone or speaker of desktop or any voice handling object.

Endif

Delete

Delete selected/current option

Edit

If use selected ‘Name’

Record name either through software menus, DTMF keys, etc..

Endif

Variations and modifications of the invention are contemplated. For example, the system according to the present invention may be modified for ‘reverse communication voice collection’ wherein the Recipient calls a person, records the voice print of the person called, and sets the FREC according to the voice print. If the called person thereafter contacts the Recipient, the call is handled according to the programmed FREC. Also, although the invention has been described as operating in association with a telephone system, the principles of the invention may be applied to any device that transmits voice (walkie-talkie, citizen band (CB) radio, etc. . . . ).

All such alternative embodiments and are believed to fall within the sphere and scope of the invention as defined by the appended claims.

What is claimed is:

1. A system for automatic handling of calls, comprising:
call processing software for answering and handling calls from incoming callers;
a voice mail system for recording and storing incoming caller voice conversations according respective conversation indices;
a voice patterns database for storing caller voice patterns in accordance with respective voice ID indices;
a voice recognition system for analyzing voice prints of said incoming callers;
a user database for storing user profiles associated with respective incoming callers, said user profiles including respective unique names, said conversation indices, said voice ID indices and associated features, policies and execution commands;
a software engine for implementing said features, policies and execution commands included in said user profiles; and
a virtual secretary which in response to being notified of an incoming call by said call processing software (1) conducts a voice conversation with said incoming caller, (2) stores said conversation in said voice mail system according to an associated conversation index, (3) activates the voice recognition software to analyze a voice print of said incoming caller during said conversation and compare said voice print with said voice prints stored in said voice patterns database, and
in the event of a match (4) using the voice ID index of the matched voice print to access an associated profile from said user database and (5) activating said software engine to implement said features, policies and execution commands included in said associated profile via said call control software,
and in the event of no match (6) creating a new profile for said incoming caller.

2. The system of claim 1, further including a user interface for modifying, enabling and disabling said user profiles.

3. The system of claim 2, wherein said use interface further includes means for activating said voice mail system to replay said voice conversations.

4. The system of claim 2 wherein said user interface is accessed via a phone.

5. The system of claim 2 wherein said user interface is accessed via a mobile phone.

6. The system of claim 2 wherein said user interface is accessed via a PDA.

7. The system of claim 2 wherein said user interface is accessed via a PC.

8. A method for automatic handling of calls, comprising:
answering a call from an incoming caller;
conducting a voice conversation with said incoming caller;
recording and storing said voice conversation according to a respective conversation index;
analyzing a voice print of said incoming caller and comparing said voice print with voice prints previously stored in accordance with respective voice ID indices;
in the event of no match then creating and storing a profile for said incoming caller, said user profile including a unique name, said conversation index, a voice ID index associated with said voice print, and associated features, policies and execution commands; and
in the event of a match using the voice ID index of the matched voice print to access an associated profile implementing said features, policies and execution commands included in said associated profile.

9. A method of reverse communication voice collection for automatic handling of calls, comprising:
placing a call to a prospective future incoming caller;
conducting a voice conversation with said prospective future incoming caller;
recording and storing said voice conversation according to a respective conversation index;
analyzing and storing a voice print of said prospective future incoming caller in accordance with an associated voice ID index; and
creating and storing a profile for said prospective future incoming caller, said user profile including a unique name, said conversation index, said voice ID index, and associated features, policies and execution commands for handling future calls from said prospective future incoming caller.
